(19) United States
(12) Patent Application Publication
(10) Pub. No.: US 2024/0062088 A1
(43) Pub. Date: Feb. 22, 2024

(54) QUANTUM LOGIC GATE OPERATION DEVICE, QUANTUM LOGIC GATE OPERATION METHOD AND A NON-TRANSITORY COMPUTER-READABLE MEDIUM

(71) Applicant: RIKEN, Wako-shi (JP)

(72) Inventors: Kentaro HEYA, Wako-shi (JP); Yasunobu NAKAMURA, Wako-shi (JP)

(21) Appl. No.: 18/447,671

(22) Filed: Aug. 10, 2023

(30) Foreign Application Priority Data
Aug. 10, 2022 (JP) 2022-127743

(51) Int. Cl. G06N 10/20; G06N 10/40

(52) U.S. Cl. CPC G06N 10/20; G06N 10/40

(57) ABSTRACT

A quantum logic gate operation device, comprising: two-qubit system in which a control qubit and a target qubit are coupled; a cross resonance drive pulse irradiator irradiating the control qubit with a cross resonance drive pulse; an echo pulse irradiation unit irradiating the control qubit with an echo pulse; and a control unit. The control unit controls the echo pulse irradiation unit such that the echo pulse irradiation unit irradiates the cross resonance drive pulse of the first phase during the first period, irradiates the cross resonance drive pulse with continuously changing the phase of the cross resonance drive pulse from the first phase to the second phase while maintaining the intensity of the cross resonance drive pulse during the second period, irradiates the cross resonance drive pulse of the second phase during the third period and irradiates an echo pulse during the second period.

### TECHNICAL FIELD

This disclosure relates to a quantum logic gate operation device, a quantum logic gate operation methods, and a non-transitory computer-readable medium.

### BACKGROUND ART

An quantum entangled gate is an implementation of the quantum logic gate operations necessary for quantum computers. Quantum entangled gates induce entanglement interactions between coupled qubits with different frequencies. This allows quantum information to be transmitted from one qubit to the other. One example of operating entangled qubits is the cross resonance gate (see, for example, Non-Patent Document 1).

### CITATION LIST

### Non-Patent Literature

[Non-Patent Document 1] “Procedure for systematically tuning up crosstalk in the cross resonance gate,” Sarah Sheldon, Easwar Magesan, Jerry M. Chow, and Jay M. Gambetta, Phys. Rev. A 93, 060302 (2016)

[Non-Patent Document 2] “Cross-Cross resonance Gate”, Kentaro Heya and Naoki Kanazawa, PRX Quantum 2, 040336 (2021)

### SUMMARY OF THE INVENTION

### Technical Problem

Conventionally, two methods have been proposed for cross resonance gates: Direct Control-X (hereinafter referred to as “DCX”) and Two-pulsed echoed Control-X (hereinafter referred to as “TPCX”). (See, for example, Non-Patent Document 2).

DCX is superior in terms of its fast gate execution speed, but has the disadvantage that it is not tolerant of errors during gate operation (ZI interaction errors, residual ZZ interaction errors, and phase relaxation errors). TPCX, on the other hand, is superior in that it is tolerant to errors during gate operation, but has the disadvantage of slow gate execution speed.

The general purpose of this invention is to realize an entangled quantum gating operation with high gating speed while maintaining adiabaticity and tolerating errors (ZI interaction errors, residual ZZ interaction errors, and phase relaxation errors) during gating operations.

### Solution to Problem

In order to solve the above problem, a quantum logic gate operation device, comprising: two-qubit system in which a control qubit and a target qubit are coupled; a cross resonance drive pulse irradiator that irradiates the control qubit with a cross resonance drive pulse having a eigen frequency of the target qubit; an echo pulse irradiation unit that irradiates the control qubit with an echo pulse to invert the quantum state of the control qubit; and a control unit, wherein the control unit controls the echo pulse irradiation unit such that the echo pulse irradiation unit irradiates the cross resonance drive pulse of the first phase during the first period of the quantum logic gate operation, irradiates the cross resonance drive pulse with continuously changing the phase of the cross resonance drive pulse from the first phase to the second phase while maintaining the intensity of the cross resonance drive pulse during the second period of the quantum logic gate operation, irradiates the cross resonance drive pulse of the second phase during the third period of the quantum logic gate operation and irradiates an echo pulse during the second period of the quantum logic gate operation.

In one embodiment, the control unit may control the echo pulse irradiation unit to perform frequency modulation of the echo pulse.

In one embodiment, the frequency modulation may follow the modulation of the resonance frequency of the control qubit.

In one embodiment, a change in the anharmonicity of the control qubits may be added to the frequency modulation of the echo pulse.

In one embodiment, the first phase may be 0 and the second phase may be π.

In one embodiment, the control and target qubits may be superconducting qubits.

In one embodiment, the control unit may include an arbitrary waveform generator.

In one embodiment, the cross resonance drive pulse irradiation unit and the echo pulse irradiation unit may be integrated.

In some embodiments, the cross resonance drive pulse irradiation unit and the echo pulse irradiation unit maybe separate units.

In one embodiment, the control unit may control the cross resonance drive pulse irradiation unit and the echo pulse irradiation unit to repeatedly perform a set of phase changes of the cross resonance drive pulses and irradiation of the echo pulses.

Another aspect of the invention is a quantum logic gate operation method for performing quantum logic gate operation using a two-qubit system in which a control qubit and a target qubit are coupled, the method comprising: a cross resonance drive pulse irradiating step of irradiating the control qubit with a cross resonance drive pulse having a eigen frequency of the target qubit; and an echo pulse irradiating step of irradiating the control qubit with an echo pulse to invert the quantum state of the control qubit, wherein the cross resonance drive pulse irradiation step comprises irradiating the cross resonance drive pulse of the first phase during the first period of the quantum logic gate operation, irradiating the cross resonance drive pulse with continuously changing the phase of the cross resonance drive pulse from the first phase to the second phase while maintaining the intensity of the cross resonance drive pulse during the second period of the quantum logic gate operation, irradiating the cross resonance drive pulse of the second phase during the third period of the quantum logic gate operation and irradiating an echo pulse during the second period of the quantum logic gate operation.

Another aspect of the invention is a non-transitory computer-readable medium encoded with a program for causing a computer to perform a quantum logic gate operation using a two-qubit system in which a control qubit and a target qubit are coupled, the program comprising: a cross resonance drive pulse irradiating step of irradiating the control qubit with a cross resonance drive pulse having a eigen frequency of the target qubit; and an echo pulse irradiating step of irradiating the control qubit with an echo pulse to invert the quantum state of the control qubit, wherein the cross resonance drive pulse irradiation step comprises irradiating the cross resonance drive pulse of the first phase during the first period of the quantum logic gate operation, irradiating the cross resonance drive pulse with continuously changing the phase of the cross resonance drive pulse from the first phase to the second phase while maintaining the intensity of the cross resonance drive pulse during the second period of the quantum logic gate operation, irradiating the cross resonance drive pulse of the second phase during the third period of the quantum logic gate operation and irradiating an echo pulse during the second period of the quantum logic gate operation.

Any combination of the above components, and any conversion of the expression of this disclosure between methods, devices, systems, recording media, computer programs, and the like, is also valid as an aspect of this disclosure.

### BRIEF DESCRIPTION OF DRAWINGS

FIG. 1 is a schematic diagram of the principle of the cross resonance gate;

FIG. 2 shows the temporal changes of cross resonance drive pulses irradiated by DCX;

FIG. 3 shows the temporal changes of cross resonance drive pulses irradiated by TPCX;

FIG. 4 shows the temporal changes of the echo pulses irradiated in TPCX;

FIG. 5 is a functional block diagram of the quantum logic gate operation device of the first embodiment;

FIG. 6 shows the temporal changes of the cross resonance drive pulses irradiated in OPCX;

FIG. 7 shows the temporal changes of echo pulses irradiated by OPCX;

FIG. 8 is an enlarged view of FIG. 6 near the second period;

FIG. 9 shows the phase variation of the cross resonance drive pulse of OPCX on the complex plane;

FIG. 10 shows the phase change of the cross resonance drive pulse of TPCX on the complex plane;

FIG. 11 shows the relationship between the drive intensity and the drive frequency of OPCX and TPCX;

FIG. 12 shows the temporal changes of the cross resonance drive pulses irradiated in the OPCX of the twice-executed type;

FIG. 13 shows the temporal changes of the echo pulse irradiated in the twice-executed OPCX;

FIG. 14 is a flowchart of the quantum logic gate operation method for the second implementation;

FIG. 15 shows the transition of the main term of Cartan coefficients in accordance with the execution of gate operations;

FIG. 16 shows the transition of the Cartan coefficients sub-order terms accompanying the execution of gate operations;

FIG. 17 shows the transition of the leakage amount of the Cartan coefficient associated with the execution of the gate operation.

### DESCRIPTION OF EMBODIMENTS

The invention will now be described by reference to the preferred embodiments. This does not intend to limit the scope of the present invention, but to exemplify the invention.

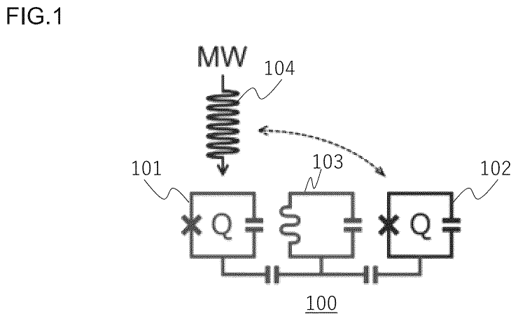

Before describing the specific embodiments, we refer to FIG. 1 to describe the underlying findings. FIG. 1 is a schematic diagram of the principle of the cross resonance gate. The two-qubit system 100 in FIG. 1 is configured as a system in which a control qubit 101 and a target qubit 102 are coupled through a coupling resonator 103. In this example, both the control qubit 101 and the target qubit 102 are formed by superconducting qubits such as transmons, but not necessarily limited to this. The resonance frequency (also called “eigen frequency”) f_{c} of the control qubit 101 and the resonance frequency (also called “eigen frequency”) fₜ of the target qubit 102 are different. For example, f_{c}=8.0 GHz and fₜ=8.8 GHz. The two-qubit system 100 shown in FIG. 1 consists of two qubits coupled through a coupling resonator, but is not necessarily limited to this. For example, the two-qubit system may be formed by direct coupling. The important point here is that the qubits with different eigen frequencies are coupled.

The control and target qubits 101 and 102 have state 0 (denoted as |0>) and state 1 (denoted as |1>), respectively. Here, state 0 and state 1 of control qubit 101 are represented as |0>_{c} and |1>_{c}, respectively, and state 0 and state 1 of target qubit 102 are represented as |0>ₜ and |1>ₜ, respectively.

In this system, a microwave pulse with the eigen frequency fₜ of the target qubit 102 is irradiated from the microwave source 104 to the control qubit 101. This microwave pulse is called a “cross resonance drive pulse”. The state of the control qubit 101 remains unchanged before and after irradiation of the cross resonance drive pulse. In other words, the state of the control qubit 101 remains the same before and after irradiation of the cross resonance drive pulse, i.e., |0>_{c→}|0>_{c} or |1>_{c→}|>_{c} (The left side of the right-facing arrow indicates the state before irradiation of the cross resonance drive pulse, and the right side indicates the state after irradiation. The same applies hereinafter). On the other hand, the state of the target qubit 102 changes according to the state of the control qubit 101. Specifically, when the state of control qubit 101 is state 0 (|0>_{c}), the state of target qubit 102 does not change. That is, if |0>_{c}, then |0>_{t→}|1>ₜ or |1>_{t→}|1>ₜ. On the other hand, when the state of the control qubit 101 is state 1 (|1>_{c}), the state of the target qubit is inverted. That is, if |1>_{c}, then |0>_{t→}|1>ₜ or |1>_{t→}|0>ₜ. In particular, a 2-input 2-output cross resonance gate that operates in this manner corresponds to a controlled NOT (CNOT) gate and is locally equivalent to a 90-degree rotation of the ZX axis. Other cross resonance drives can implement (A*ZX+B*IX) axis rotations that result in arbitrary rotations to the target qubit depending on the state of the control qubit (A and B are arbitrary real coefficients) by additional microwave irradiation, called crosstalk cancellation drive. The ZX axis rotation refers to an operation such that the target side rotates positively when the control side is 0, and the target side rotates negatively when the control side is 1. Also, (ZX−IX) axis rotation refers to an operation in which the subject is stationary when the control side is 0 and the subject moves when the control side is 1.

### Conventional Technique 1: DCX

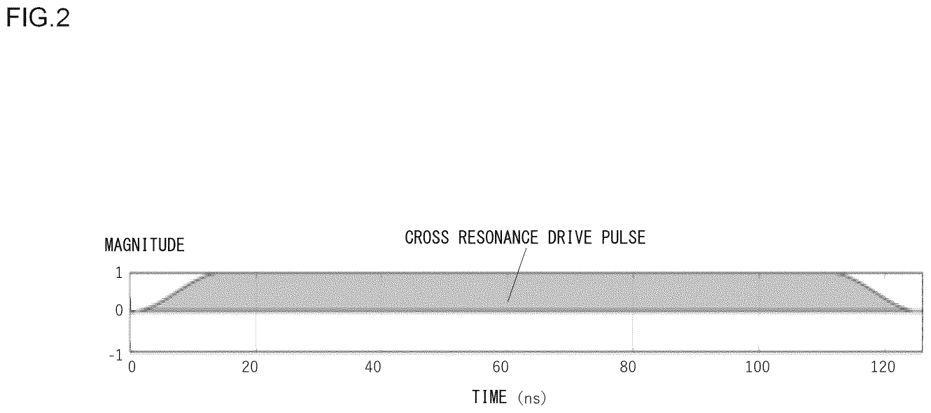

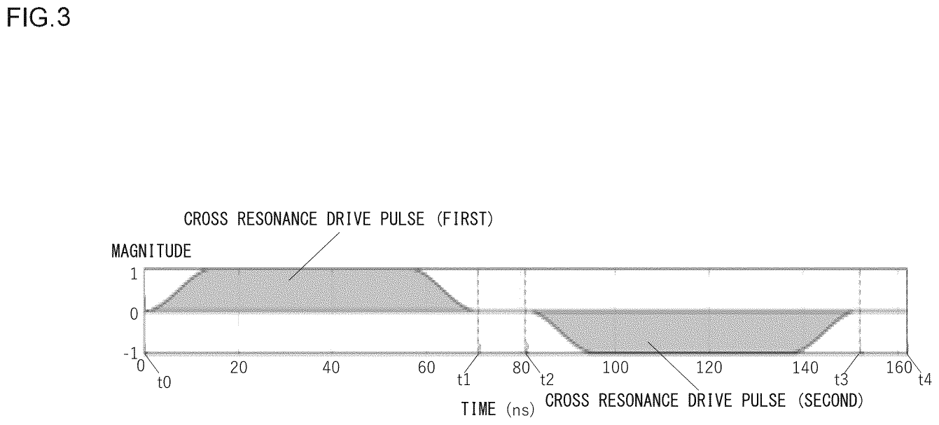

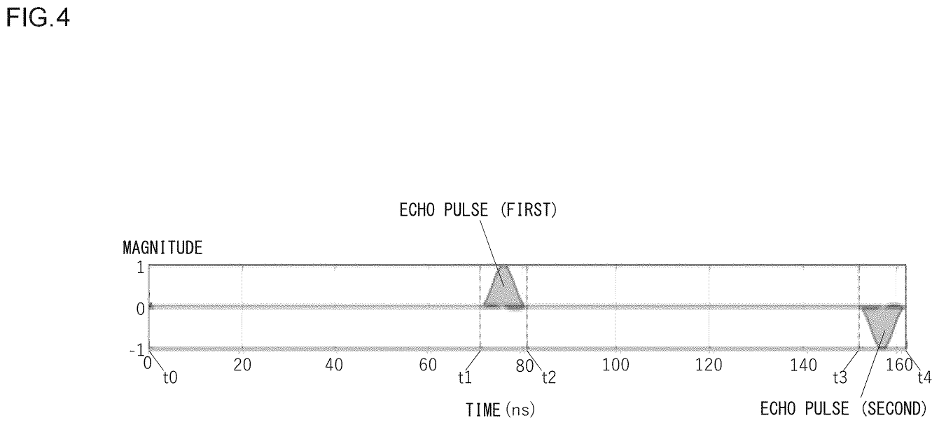

As the first example of a conventional technique for realizing across resonance gate, DCX is described: in DCX, during the quantum gate operation, a cross resonance drive pulse is irradiated only once to the control qubit 101. This propagates the quantum information of one qubit (control qubit 101) to the other qubit (target qubit 102), as described above. However, DCX has the problem that it is not error tolerant. FIG. 2 shows an example of the temporal changes of a cross resonance drive pulse irradiated by DCX. In this example, the horizontal axis (time) is in ns (nanoseconds). As shown in the figure, the irradiation time (gate execution time) of the cross resonance drive pulse is about 125 ns. The vertical axis (amplitude) is normalized by 1 for magnitude, positive for phase 0, and negative for phase π (FIGS. 3 and 4 are similar).

The three types of errors present in the cross resonance gate are explained here. When a control qubit 101 is irradiated with a cross resonance drive pulse (in the following, this operation is sometimes referred to as “applying a cross resonance drive” or “gating”) , an interaction called the ZX interaction takes place between the control qubit 101 and the target qubit 102. The ZX interaction is the interaction between the control qubit 101 and the target qubit 102, desirable interaction for a cross resonance gate. However, in reality, apart from the ZX interaction, there are other undesirable interactions, specifically called the ZI interaction and the residual ZZ interaction, that operate on the cross resonance gate. These can cause errors in the execution of the cross resonance gate.

### Error 1: ZI Interaction Error

As mentioned above, in the cross resonance gate, the control qubit 101 is irradiated with a cross resonance drive pulse with a frequency fₜ different from their own eigen frequency f_{c}. At this time, an effect called drive-induced AC Stark shift is activated, and the resonance frequency of the control qubit 101 shifts from its original eigen frequency f_{c}. The error caused by this frequency shift is called the ZI interaction error.

### Error 2: Residual ZZ Interaction Error

Residual interactions (residual ZZ interactions) between a control qubit 101 and a target qubit 102, which originate from the coupling between the two qubits, exist even when cross resonance drive is not applied. Such residual ZZ interactions are also undesirable for the cross resonance gate and can cause errors. Errors caused by such residual ZZ interactions are called residual ZZ interaction errors.

### Error 3: Phase Relaxation Error

The phase of the quantum state of the control qubit 101 fluctuates in time (in other words, the phase relaxes with time). The error caused by such temporal relaxation of the phase is called the phase relaxation error.

DCX has been found to have no tolerance for these three errors (i.e., ZI interaction error, residual ZZ interaction error, and phase relaxation error), which is a major drawback.

### Conventional Technique 2: TPCX

As a second example of a conventional technique to realize cross resonance gating, we describe TPCX, a technique developed to provide tolerance to the three errors mentioned above. The irradiation TPCX is unique in that it irradiates the cross resonance drive pulse twice.

In TPCX, the first cross resonance drive pulse is first irradiated to a control qubit 101 in the first half of the gating operation. After this first irradiation, a pulse (called an “echo pulse” or “X-π pulse”) is irradiated to the control qubit 101 to invert the quantum state of the control qubit 101. Thus, after the first cross resonance drive pulse is irradiated, the quantum state of the control qubit 101 is inverted. Then, in the latter half of the gating operation, the second cross resonance drive pulse is irradiated to the control qubit 101. However, the phase of the second cross resonance drive pulse should be the opposite phase of the first cross resonance drive pulse. Finally (after the second irradiation), an echo pulse is irradiated to the control qubit 101 to invert the quantum state of the control qubit 101. FIG. 3 shows an example of the temporal changes of the cross resonance drive pulse irradiated by TPCX. FIG. 4 shows an example of the temporal changes of the echo pulses irradiated by TPCX. The first cross resonance drive pulse is irradiated between t0 and t1. The first echo pulse is irradiated between t1 and t2. The second cross resonance drive pulse is irradiated between t2 and t3. The second echo pulse is irradiated between t3 and t4.

Here, we note the following properties. The ZX interaction follows the phase of the cross resonance drive pulse to be irradiated. That is, irradiation of a cross resonance drive pulse with a positive sign produces a ZX interaction with a positive sign. Conversely, irradiation of a cross resonance drive pulse with a negative sign produces a ZX interaction with a negative sign. On the other hand, the ZI and ZZ interactions always have a specific phase, regardless of the sign of the cross resonance drive pulse. That is, the ZI and ZZ interactions are always positive or negative regardless of whether the sign of the cross resonance drive pulse is positive or negative. In addition, when the quantum state of the control qubit 101 is inverted by the echo pulse, the ZX interaction, the ZI interaction, and the ZZ interaction all have their phases inverted.

Thus, if the phase of the first cross resonance drive pulse and the phase of the second cross resonance drive pulse are reversed and the echo pulse is irradiated before the second cross resonance drive pulse, the ZX interaction acts as an interaction of the same sign throughout the first and second half of the gating operation. Thus, the ZX interaction acts as a valid interaction during the entire gating operation. On the other hand, the ZI and ZZ interactions act as interactions with opposite signs in the first and second halves of the gate operation. Therefore, the ZI and ZZ interactions cancel each other out during the entire gating operation. Thus, according to TPCX, undesirable ZI interactions, residual ZZ interactions, and phase relaxation errors can be eliminated while achieving the desired ZX interactions.

However, TPCX has the disadvantage of slow gate execution speed. In general, when gating, the gate drive speed is determined by the pulse area of the cross resonance drive pulses shown in FIGS. 2 and 3. In other words, the gate operation terminates when this pulse area reaches a predetermined value. Therefore, to increase the gate execution speed, it is necessary to provide as large a pulse area as possible in as short a time as possible. As shown in FIG. 3, in TPCX, there are two pulse rises and two pulse falls, and echo pulse irradiation is performed. These time periods (also called pulse edges) correspond to pulse blank periods. Therefore, the gate execution speed of TPCX is slower than that of DCX because of this pulse blank period. In practice, the pulse edge occupies about 10% to 20% of the pulse area.

OPCX, which is explained below using an embodiment, aims to resolve the issues that DCX and TPCX have, and to achieve both high error tolerance and fast gate execution speed.

### The First Embodiment

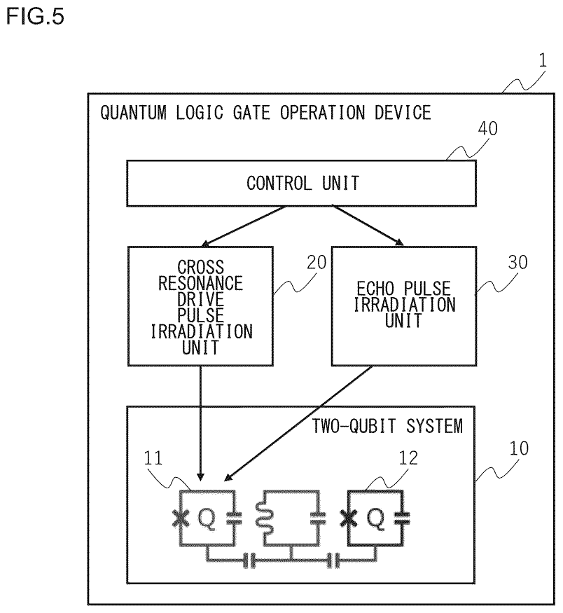

FIG. 5 shows a functional block diagram of the first embodiment of quantum logic gate operation device 1. The quantum logic gate operation device 1 is equipped with a two-qubit system 10, a cross resonance drive pulse irradiation unit 20, an echo pulse irradiation unit 30, and a control unit 40. two-qubit system 10 is formed by coupling a control qubit 11 and a target qubit 12. The cross resonance drive pulse irradiation unit 20 irradiates the control qubit 11 with a cross resonance drive pulse having the eigen frequency of the target qubit 12. The echo pulse irradiation unit 30 irradiates the control qubit 11 with an echo pulse to invert the quantum state of the control qubit 11.

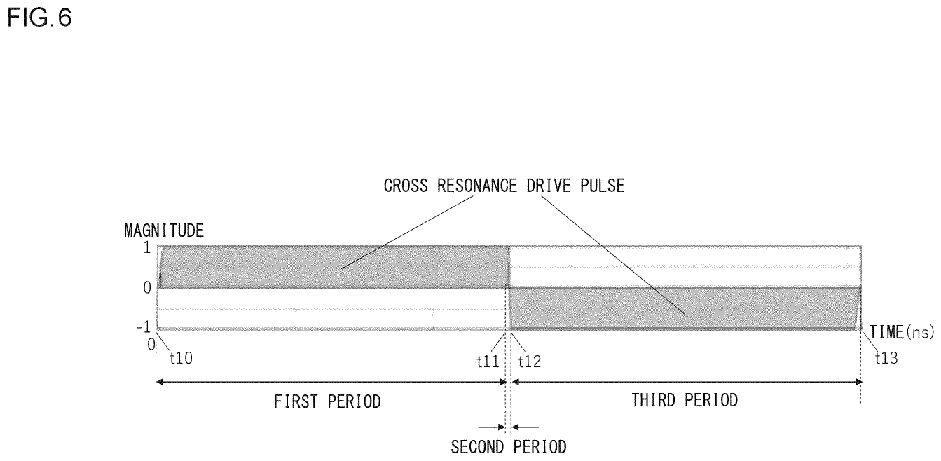

The control of cross resonance drive pulse irradiation and echo pulse irradiation in this embodiment is explained below with reference to FIGS. 6 to 8.

FIG. 6 shows the temporal changes of the cross resonance drive pulses irradiated by OPCX. As shown in the figure, the cross resonance drive pulse is irradiated from t10 to t13. In other words, in OPCX, the cross resonance drive pulse is irradiated only once for the entire duration of the gating operation. In this respect, OPCX differs from TPCX, in which the cross resonance drive pulse is irradiated twice. However, between t10 and t11 (hereinafter referred to as the “first period”), the phase of the cross resonance drive pulse is 0. Between t11 and t12 (hereinafter referred to as the “second period”), the phase of the cross resonance drive pulse changes continuously from 0 to π while the intensity of the cross resonance drive pulse is kept constant. During the period from t12 to t13 (hereinafter referred to as the “third period”), the phase of the cross resonance drive pulse is π.

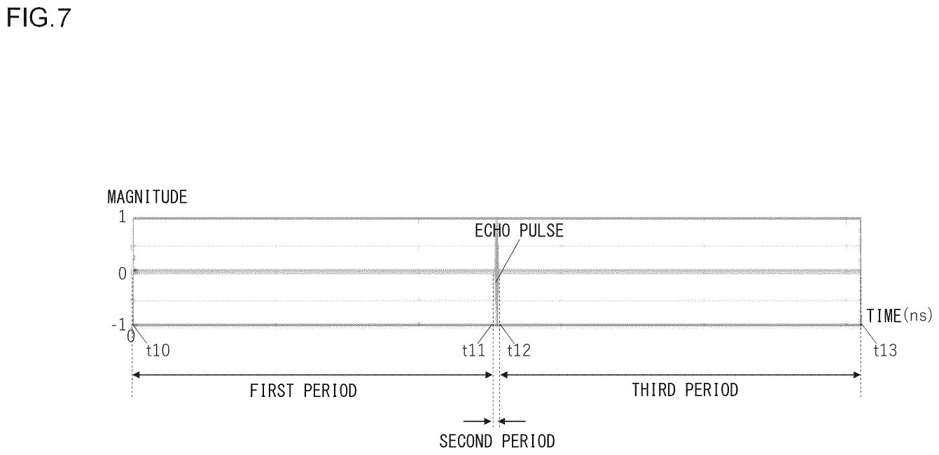

FIG. 7 shows the temporal changes of the echo pulses irradiated by OPCX. As illustrated, the echo pulses are irradiated between t11 and t12, i.e., during the second period.

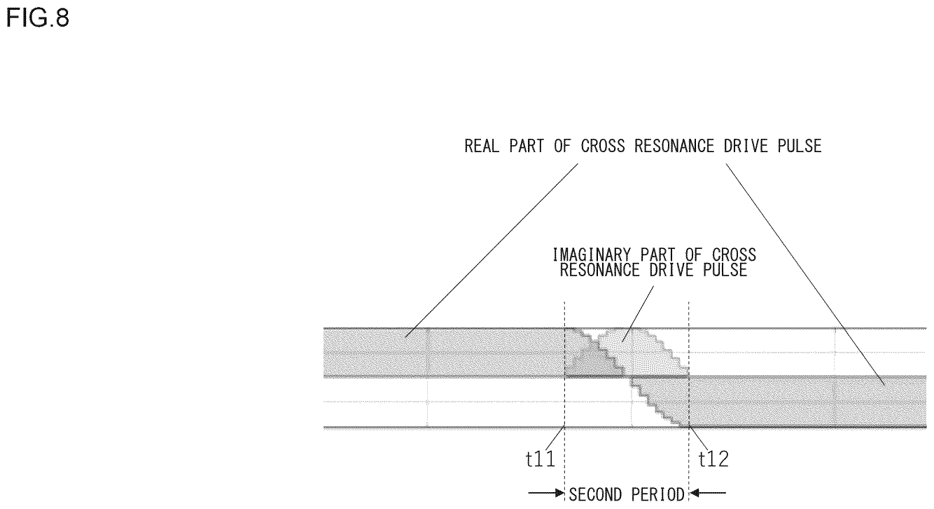

FIG. 8 is an enlarged view of FIG. 6 near the second period. FIG. 8 shows the real and imaginary parts of the cross resonance drive pulse displayed in complex numbers. As illustrated, in the second period, a cross resonance drive pulse of non-zero intensity is irradiated and its phase is inverted.

Thus, OPCX performs the phase inversion of the cross resonance drive pulse and the irradiation of the echo pulse. Thus, OPCX, like TPCX, is resistant to ZI interactions, residual ZZ interactions, and phase relaxation errors.

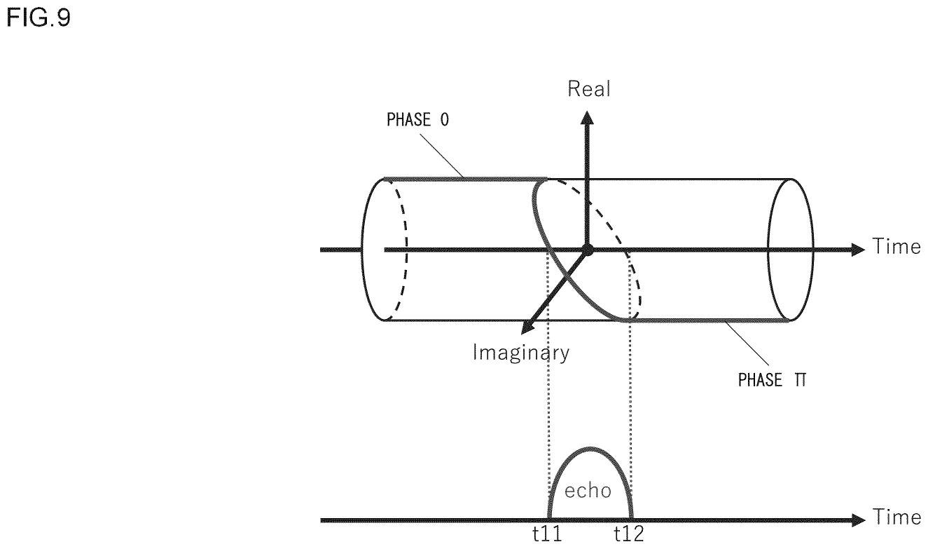

FIG. 9 shows the phase variation of the cross resonance drive pulse of OPCX in the complex plane. As illustrated, the vector of cross resonance drive pulses, which was constant intensity and constant phase (0) until t11, begins to change phase at t11. In the second period (t11 to t12), the phase of the cross resonance drive pulse changes from 0 to π as it smoothly traces on the cylinder while rotating, keeping the intensity constant. Echo pulses are irradiated during the second period; after the echo pulse irradiation ends at t12, the cross resonance drive pulse is continuously irradiated with a phase of π, and then continues to be irradiated with constant intensity and constant phase (π).

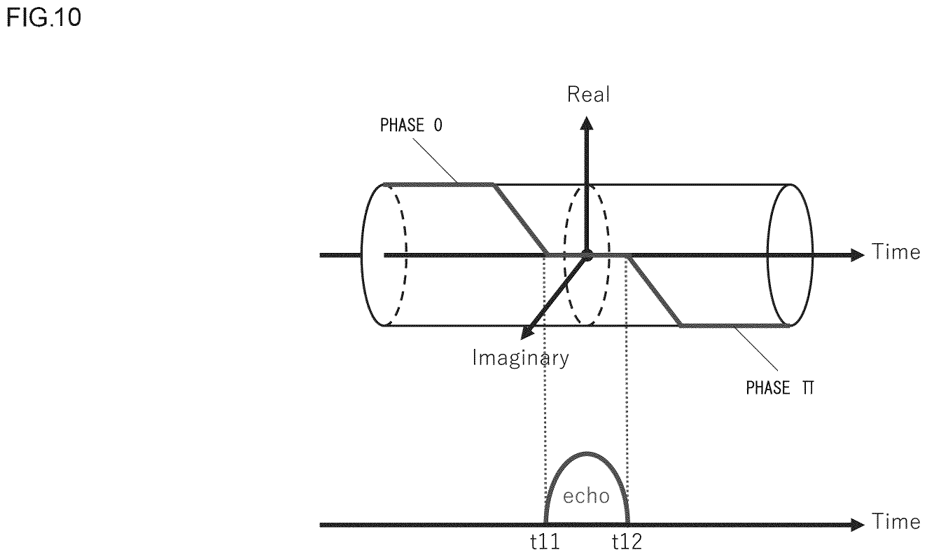

For comparison, FIG. 10 shows the phase change of the cross resonance drive pulse of the TPCX on the complex plane. As shown in the figure, the vector of cross resonance drive pulses, which was constant intensity and constant phase (0) until t1, begins to decrease in intensity before the echo pulse is irradiated. At t1, the intensity of the cross resonance drive pulse becomes zero. From t1 to t2, the echo pulse is irradiated. When the echo pulse irradiation ends at t2, the phase of the cross resonance drive pulse discontinuously reverses to π, and the intensity (absolute value of the intensity) of the cross resonance drive pulse vector increases until it reaches a constant intensity.

The control of cross resonance drive pulse irradiation and echo pulse irradiation as described above is performed by the control unit 40. In other words, in this embodiment, the control unit 40 controls the cross resonance drive pulse irradiation unit 20 to irradiate the cross resonance drive pulse of the first phase during the first period of the quantum logic gate operation. Then, during the second period of the quantum logic gate operation, the control unit 40 controls the cross resonance drive pulse irradiation unit 20 so that the cross resonance drive pulse is irradiated while continuously changing the phase of the cross resonance drive pulse from the first phase to the second phase while maintaining the intensity of the cross resonance drive pulse. The control unit 40 then controls the cross resonance drive pulse irradiation unit 20 to irradiate the cross resonance drive pulse of the second phase during the third period of the quantum logic gate operation. The control unit 40 then controls the echo pulse irradiation unit 30 to irradiate an echo pulse during the second period.

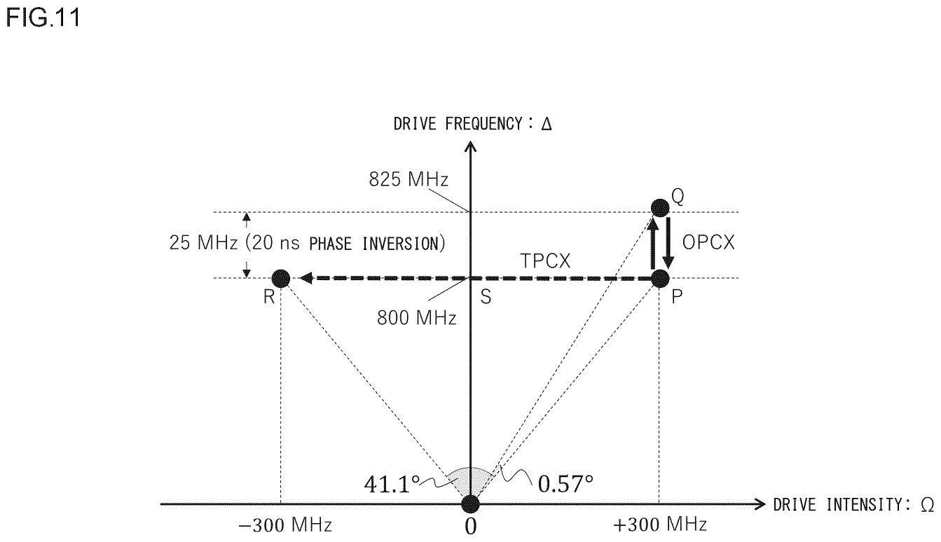

FIG. 11 is used below to explain the effects of this method of operation. FIG. 11 shows the relationship between the drive intensity Ω and drive frequency Δ of OPCX and TPCX. The horizontal axis shows the intensity of the cross resonance drive pulse (note that the intensity with units of energy is divided by Planck's constant and converted to units of frequency (MHz). Also, a phase of 0 is considered positive and a phase of π is considered negative). In this example, the drive intensity Ω=300 MHz for both OPCX and TPCX. The drive frequency A on the vertical axis corresponds to the difference between the frequency of the microwave pulse irradiated to the control qubit and the eigen frequency of the control qubit. In this example, the frequency of the microwave pulse=8.8 GHz and the eigen frequency of the control qubit=8.0 GHz, so Δ=800 MHz. FIG. 11 shows how the echo pulse modulates the drive frequency Δ and drive strength Ω in OPCX and TPCX.

The phase inversion of the cross resonance drive pulse in OPCX corresponds to temporarily changing the drive frequency Δ while keeping the drive strength Ω at +300 MHz. In this example, the phase is inverted from 0 to π at 20 ns. This temporary change in drive frequency Δ is then 25 MHz. Therefore, the change in the cross resonance drive pulse in OPCX is indicated by the solid upward arrow from point P to point Q and the solid downward arrow from point Q back to point P in the figure. On the other hand, the change of the cross resonance drive pulse in TPCX is indicated by a dashed arrow from point P through point S to point R in the figure, since the drive intensity Ω changes from +300 MHz to −300 MHz while the drive frequency Δ is maintained at 800 MHz.

The smoothness of the temporal change of the pulse can be evaluated by the non-adiabatic transition ε, which is shown in the following equation (1) (adiabatic theorem).

$$\begin{matrix}[ equation 1 ] & \\ \frac{\vert \frac{d}{d t} arctan ( \frac{Ω ( t )}{Δ ( t )} ) \vert}{\vert \sqrt{{Δ}^{2} ( t ) + {Ω}^{2} ( t )} \vert} ∼ ε & ( 1 )\end{matrix}$$

The smaller this non-adiabatic transition ε is, the smoother the pulse changes in time. This prevents undesirable energy transitions. In other words, the smaller the nonadiabatic transition ε is, the more desirable the result is for quantum logic gate operation. The numerator in equation (1) represents the velocity of the change of argument of a point with respect to the origin when the point moves on the coordinate plane in FIG. 11. Therefore, to keep ε small, the velocity of the change of argument should be as slow as possible. On the other hand, the denominator of Equation (1) represents the distance of a point on the coordinate plane of FIG. 11 from the origin. Therefore, to reduce ε, the distance from the origin should be as far as possible.

From this perspective, we compare OPCX and TPCX: In OPCX, indicated by the two solid arrows, when the state changes from point P to point Q to point P, the total amount of argument change relative to the origin is 0.57°×2=1.14°. The distance to the origin gradually increases from point P, reaches a maximum at point Q, then begins to decrease, and returns to its original value at point P. On the other hand, in TPCX indicated by the dashed arrow, the magnitude of the change in argument relative to the origin when the state changes from point P to point S to point R is 41.1°. The distance to the origin gradually decreases from point P, reaches a minimum at point S, then begins to increase, and returns to its original value at point R. As can be seen from the above, the magnitude of argument change is smaller for OPCX than for TPCX. Therefore, for the same value of ε, OPCX can change its state in a shorter time (see the numerator in equation (1)). The distance from the origin is longer for OPCX than for TPCX. Therefore, the value of can be smaller for OPCX (see denominator in Equation (1)).

From the above, it can be seen that OPCX can perform gate operations in a shorter time than TPCX without increasing the value of ε (in other words, without compromising quality). Furthermore, as shown in FIG. 8, in OPCX, the cross resonance drive pulse is also irradiated during the period when the echo pulse is irradiated (second period). In other words, the ZX interaction is also active during the second period. In contrast, in TPCX, no cross resonance drive pulses are irradiated during the period when echo pulses are irradiated (t1-t2 in FIGS. 3 and 10). In this case, the ZX interaction does not work during the period from t1 to t2. From this point of view, it can be seen that OPCX achieves gate operation faster than TPCX.

Furthermore, OPCX is also advantageous in terms of error tolerance. In other words, OPCX has a smaller value of ε, which results in smaller errors. Furthermore, the gate operation time of OPCX is shorter than that of TPCX, so the probability of error occurrence can be reduced.

As explained above, this method can realize quantum entangled gate operations with high gate execution speed while maintaining adiabaticity and tolerating ZI interaction errors, residual ZZ interaction errors, and phase relaxation errors.

There are various embodiments of this system, including the following.

### Frequency Modulation of Echo Pulses

In one embodiment, the control unit 40 may control the echo pulse irradiation unit 30 to frequency modulate the echo pulse. As mentioned above, in OPCX, the cross resonance drive pulse is also irradiated during the period when the echo pulse is irradiated (second period). At this time, the echo pulse should be modulated. This feature is explained below.

When a superconducting qubit is irradiated with non-resonant microwaves, different energy levels in the superconducting qubit will have coupling with each other via the irradiated microwave photons. As a result, the following effects (drive-induced AC Stark effect) are produced, which are anti-crossing each other.

This section describes the time evolution when the drive frequency ω_{d} is sufficiently far from both transition frequencies ω_{ge} and ω_{ef}. In this case, each energy level of the three-level system shifts under the influence of the AC Stark shift for both the g-e and e-f transitions. To confirm this, the rotational coordinate system of the drive:

[equation 2]

Û(t)=exp(i2ω_{d}t|f [symbol] [symbol] f|+iω_{d}t|e [symbol] [symbol] e|) (2)

and then using the rotational approximate wave, a time-independent Hamiltonian:

$$\begin{matrix}[ equation 3 ] & \\ \hat{H} / ℏ = ( \begin{matrix}2 δ + α & Ω / \sqrt{2} & 0 \\ {Ω}^{*} / \sqrt{2} & δ & Ω / 2 \\ 0 & {Ω}^{*} / 2 & 0\end{matrix} ) & ( 3 )\end{matrix}$$

can be obtained, where δ=ω_{ge}−ω_{d} is the detuning of the g-e transition frequency ω_{ge} with respect to the driving frequency ω_{d}. The energy shift of each level due to driving is obtained by calculating the second-order perturbation energy:

$$\begin{matrix}[ equation 4 ] & \\ Δ {E}_{f} / ℏ = \frac{{\vert Ω \vert}^{2}}{2 ( δ + α )} & ( 4 )\end{matrix}$$

$$\begin{matrix}[ equation 5 ] & \\ Δ {E}_{e} / ℏ = - \frac{{\vert Ω \vert}^{2}}{2 ( δ + α )} + \frac{{\vert Ω \vert}^{2}}{4 δ} & ( 5 )\end{matrix}$$

$$\begin{matrix}[ equation 6 ] & \\ Δ {E}_{g} / ℏ = - \frac{{\vert Ω \vert}^{2}}{4 δ} & ( 6 )\end{matrix}$$

The result is as follows.

From the above, it can be seen that the resonance frequency ω_{q} (energy difference between the first and ground levels) and anharmonicity α_{q} (energy difference between the first and second excited transitions) of the superconducting qubit are modulated by the irradiation of non-resonant microwaves. The driving frequency of the echo pulse should be modulated to follow the modulation of the resonance frequency, δω_{q}.

Generally, in modern superconducting quantum computers, a qubit-controlled microwave pulse is generated by multiplying a stationary microwave generated from a local oscillator with a fixed driving frequency (˜several GHz) with an arbitrary microwave waveform generated from an arbitrary waveform generator with a variable frequency (˜several hundred MHz). Therefore, modulation of the drive frequency of the echo pulse is performed by the latter arbitrary waveform generator. The actual output waveform is B(t)=A(t)exp(−iδω_{q}t), which is the microwave waveform A(t) originally desired to be output from the arbitrary waveform generator, plus complex modulation corresponding to the modulation frequency δω_{q}.

More precisely, the modulation (called DRAG) to be added to the echo pulse in order to suppress nonadiabatic transitions also changes by modulating the value of anharmonicity α_{q} by δα_{q}. In this modulation, a modulation that multiplies the time derivative of the echo pulse waveform by a factor is added to the complex component of the echo pulse. Namely:

$$\begin{matrix}[ equation 7 ] & \\ C ( t ) = ( A ( t ) + \frac{i}{2 ( {α}_{q} + {δα}_{q}} \frac{d}{dt} A ( t ) ) {e}^{- i {δω}_{q} t} & ( 7 )\end{matrix}$$

is the output waveform. Therefore, by incorporating the change δα_{q} in anharmonicity α_{q} into the modulation of the echo pulse, a more accurate gate operation can be achieved.

According to this embodiment, the echo pulse can be more appropriately irradiated during the second period.

### CNOT Gate and Root CNOT Gate

In the previous example, the CNOT gate was realized by setting the first and second periods appropriately. However, not limited to this, a root CNOT gate, which is a square root gate, may be realized by setting the first and second periods appropriately.

In a two-qubit system irradiated with a cross resonance drive pulse, a ZX-axis rotation of angular velocity ω occurs. In this case, the CNOT gate is locally equivalent to a 90-degree rotation of the ZX axis and the root CNOT gate is locally equivalent to a 45-degree rotation of the ZX axis. The CNOT gate can be realized by setting the irradiation time t of the cross resonance drive pulse to t=π/(2ω) and t=π/(4ω) for the root CNOT gate.

According to this embodiment, various logic gates can be realized.

### Degree of Freedom of Rotational Axis and Rotational Angle

In the previous example, the phase of the cross resonance drive pulse was varied from 0 to π by rotation around ZX. However, this is not limited to this, and the phase of the cross resonance drive pulse can be changed by rotation around any axis, or by rotation of any angle.

According to this embodiment, the degree of freedom of configuration can be increased.

### Superconducting Quantum Bit

In one embodiment, the control qubit 11 and target qubit 12 may be superconducting qubits, such as transmons.

According to this embodiment, a quantum logic gate operation device can be realized using superconducting qubits.

### Arbitrary Waveform Generator

In one embodiment, the control unit may include an arbitrary waveform generator.

According to this embodiment, a quantum logic gate operation device can be realized using an arbitrary waveform generator, which is an existing device.

### Integral Type Embodiment

In one embodiment, the cross resonance drive pulse irradiation unit 20 and the echo pulse irradiation unit 30 maybe integrated. In other words, the cross resonance drive pulse irradiation unit and the echo pulse irradiation unit 30 may be formed by a single integrated hardware.

According to this embodiment, the number of devices in the system can be reduced and a simple configuration can be achieved.

### Separate Type Embodiment

In one embodiment, the cross resonance drive pulse irradiation unit 20 and the echo pulse irradiation unit 30 may be separate units. In other words, the cross resonance drive pulse irradiation unit 20 and the echo pulse irradiation unit 30 may be formed by separate and independent hardware.

According to this embodiment, the degree of freedom of configuration can be increased.

### OPCX With Multiple Executions

The phase inversion and echo pulse irradiation by the OPCX gate may cause an unwanted entanglement generation error, although it is very small. It may be possible to eliminate this entanglement error by modifying the echo pulse waveform. More simply, however, phase inversion and echo pulse irradiation can be performed twice during the OPCX run in order to cancel out the unwanted entanglement error.

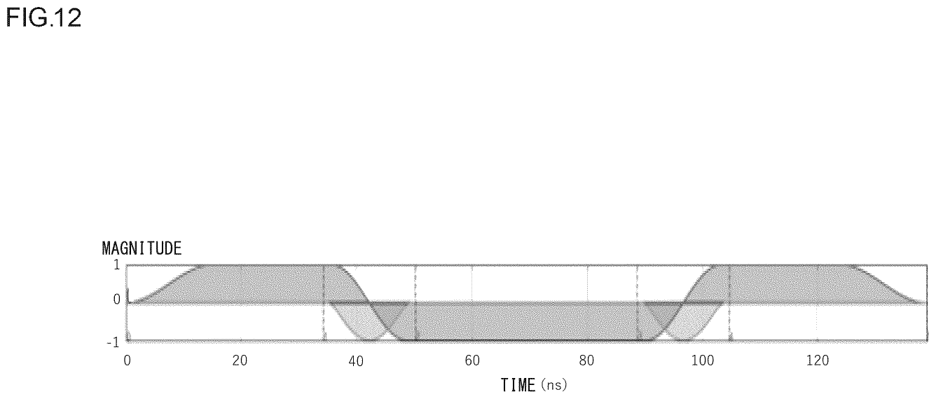

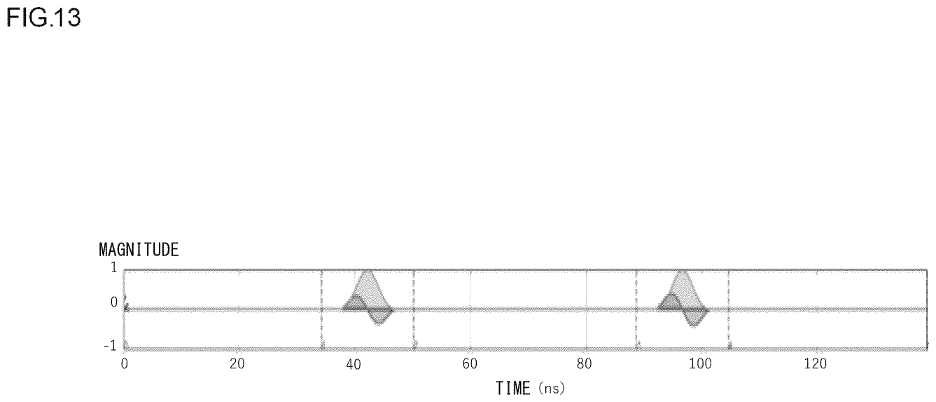

FIG. 12 shows the temporal changes of the cross resonance drive pulses irradiated in a two-run OPCX. FIG. 13 shows the temporal changes of the echo pulses irradiated in a two-run OPCX. As illustrated in the figure, in this embodiment, the set of cross resonance drive phase inversion and echo pulse irradiation by OPCX is repeated twice. The number of repetitions is not limited to two, but may be any number of times.

Thus, more robust error tolerance can be obtained by performing multiple repetitions of the phase inversion and echo pulse irradiation operation of the cross resonance drive during OPCX gate execution. Note that each increase in the number of echoes increases the execution time for the desired entanglement generation, but there is a tradeoff in that the perturbation order of the error that can be eliminated is increased.

### The Second Embodiment

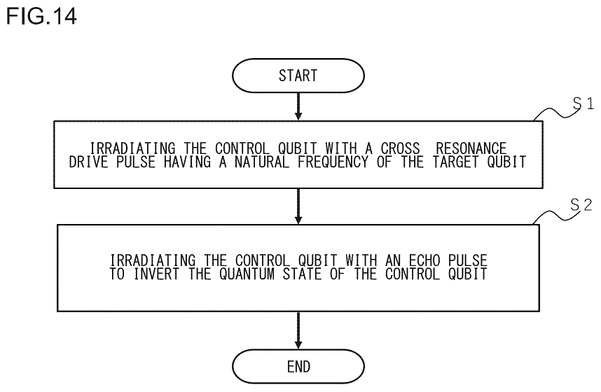

The second embodiment is a quantum logic gate operation method that performs quantum logic gate operations using a two-qubit system in which a control qubit and a target qubit are coupled. FIG. 14 is a flowchart of the quantum logic gate operation method. The method includes a cross resonance drive pulse irradiation step S1 and an echo pulse irradiation step S2. In the cross resonance drive pulse irradiation step S1, the method irradiates the control qubit with a cross resonance drive pulse of the first phase having the eigen frequency of the target qubit. In this case, during the first period of the quantum logic gate operation, the cross resonance drive pulse of the first phase is irradiated, and during the second period of the quantum logic gate operation, the cross resonance drive pulse is irradiated with continuously changing the phase of the cross resonance drive pulse from the first phase to the second phase while maintaining the intensity of the cross resonance drive pulse and in the third period of quantum logic gate operation, the cross resonance drive pulse of the second phase is irradiated. In the echo pulse irradiation step S2, the method irradiates the control qubit with an echo pulse to invert the quantum state of the control qubit. In this case, the echo pulse is irradiated during the second period.

According to this embodiment, a two-qubit system can be used to perform entangled quantum gating operations that are adiabatic, fast in gate execution speed, and tolerant of ZI interaction errors, residual ZZ interaction errors, and phase relaxation errors.

### The Third Embodiment

The third embodiment is a non-transitory computer-readable medium encoded with a program. This program causes the computer to perform the cross resonance drive pulse irradiation step S1 and the echo pulse irradiation step S2. In the cross resonance drive pulse irradiation step S1, the method irradiates the control qubit with a cross resonance drive pulse of the first phase having the eigen frequency of the target qubit. In this case, during the first period of the quantum logic gate operation, the cross resonance drive pulse of the first phase is irradiated, and during the second period of the quantum logic gate operation, the cross resonance drive pulse is irradiated with continuously changing the phase of the cross resonance drive pulse from the first phase to the second phase while maintaining the intensity of the cross resonance drive pulse and in the third period of quantum logic gate operation, the cross resonance drive pulse of the second phase is irradiated. In the echo pulse irradiation step S2, the method irradiates the control qubit with an echo pulse to invert the quantum state of the control qubit. In this case, the echo pulse is irradiated during the second period.

According to this embodiment, it is possible to implement in software a program to perform entangled quantum gating operations using a two-qubit system with high gate execution speed while maintaining adiabaticity and tolerating ZI interaction errors, residual ZZ interaction errors and phase relaxation errors.

### Evaluation

According to the inventors' evaluation, OPCX achieves the same performance as TPCX with respect to error tolerance. Regarding gate operation speed, TPCX is about 20% slower than DCX, while OPCX is only about 10% slower than DCX.

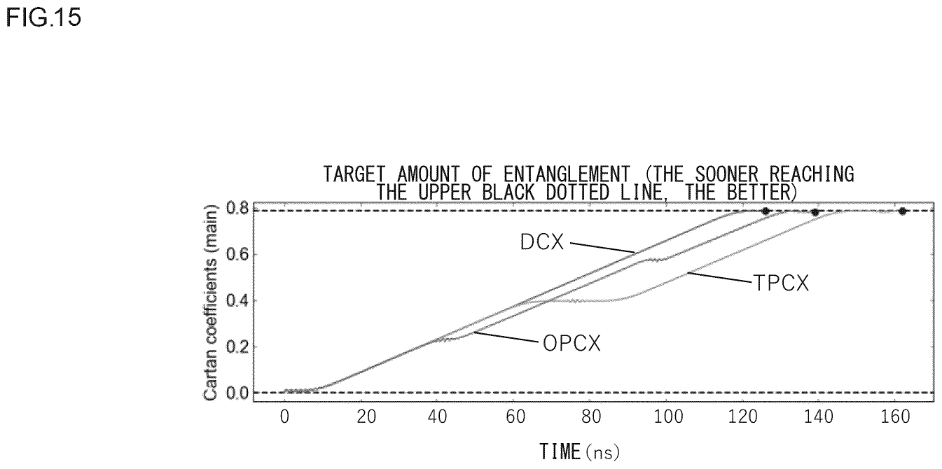

In the following, we will compare DCX, TPCX, and OPCX in terms of entanglement generation speed (Cartan coefficient) and leakage generation, referring to FIGS. 15 through 17.

FIG. 15 shows the evolution of the main term of the Cartan coefficient with the execution of the gate operation. The main term of the Cartan coefficient is a coefficient that takes values from 0 to π/4. When the main term of the Cartan coefficient is 0, no entanglement occurs, and when it is π/4, it is equivalent to a CNOT gate. Therefore, the faster the Cartan coefficient main term reaches π/4, the faster the gate is. In FIG. 15, the DCX gate reaches π/4 in 126 ns, the OPCX gate in 137 ns, and the TPCX gate in 162 ns, it can be seen that the speed is fast in that order. In OPCX and TPCX, there is a region where the increase in Cartan coefficient stalls once in the middle of the gate, corresponding to the pulse edge of the cross-resonance drive and the echo pulse execution section. In the case of the OPCX gate, unlike the TPCX gate, it is not necessary to reset the intensity of the cross resonance drive to zero, so the time span in which the increase in the Cartan coefficient stagnates is extremely short (Note that the echo pulse lengths are the same for OPCX and TPCX).

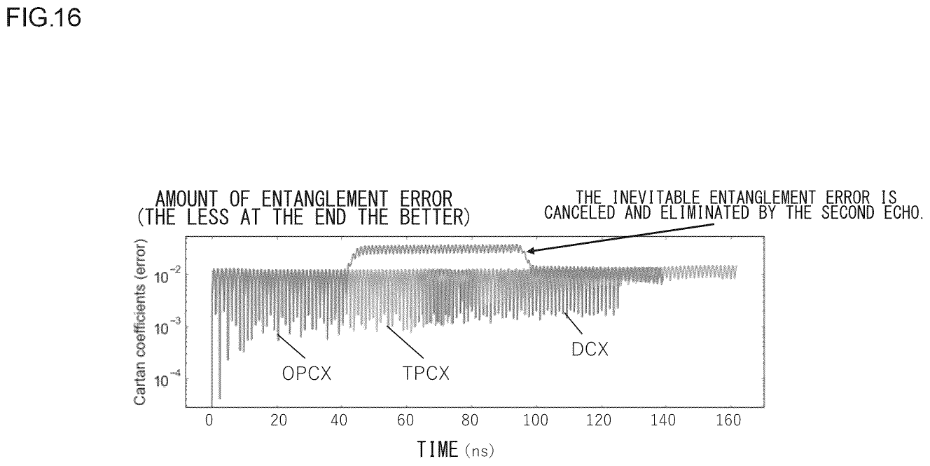

FIG. 16 shows the evolution of the Caftan coefficient sub-order term as the gate operation is performed. The Cartan coefficient sub-order term is the coefficient corresponding to the unwanted entanglement component resulting from the gating operation. Note that in the OPCX gate, the phase rotation of the cross resonance drive and the echo pulse irradiation once introduced a small amount of unwanted entanglement error. In order to eliminate this unwanted entanglement error, the echo pulse is irradiated twice. As a result, the entanglement error is successfully eliminated. At the end of the gate, the amount of entanglement error for DCX, TPCX, and OPCX all remain the same.

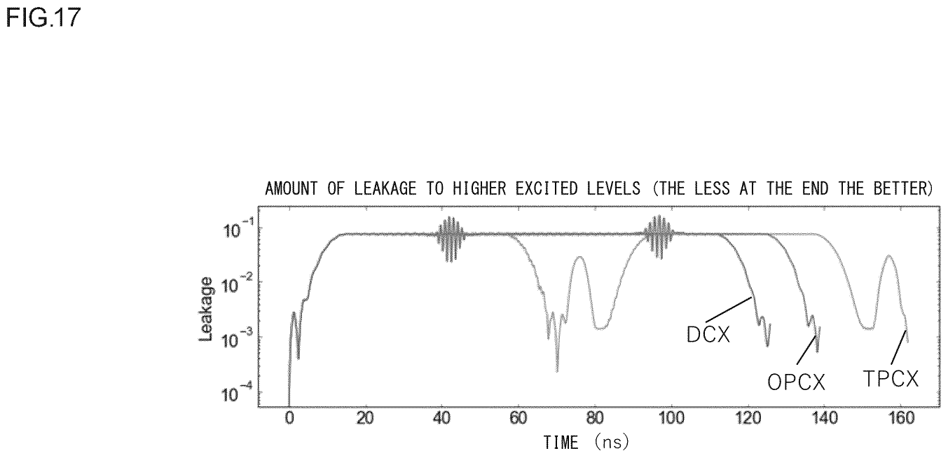

FIG. 17 shows the leakage amount of Cartan coefficients with gate operation execution. The leakage amount represents the amount of superconducting qubits that are ejected from the low-energy level space as a result of gate execution. Of particular importance is the leakage amount after the end of the gate execution. Basically, more leakage is created by irradiating a stronger cross resonance drive. Since the numerical calculations here employ the same cross resonance drive strength for DCX, TPCX, and OPCX, it can be seen that the final leakage is roughly equivalent for all of them. This fact suggests that the fast cross resonance drive phase reversal in OPCX, as well as simultaneously irradiated echo pulses, etc., do not produce unwanted leakage.

The above comparative study using numerical calculations shows that the OPCX gate can generate entanglement faster than the TPCX gate.

The above disclosure is based on the embodiment. It is understood by those skilled in the art that this embodiment is an example, and that various variations are possible in the combination of each component and each processing process, and that such variations are also within the scope of this disclosure.

### SQUID

In the above embodiment, microwave pulses whose driving frequency is modulated are irradiated to the control qubit as echo pulses. However, the embodiment is not limited to this. For example, in the case of a superconducting qubit with a variable resonance frequency in which a circuit element called a superconducting quantum interference device (SQUID) is incorporated, it is possible to realize an embodiment in which periodic modulation of the magnetic flux bias is applied to the SQUID.

In understanding the technical ideas abstracted from the embodiments and variations, the technical ideas should not be interpreted as limited to the contents of the embodiments and variations. The aforementioned embodiments and variations are merely concrete examples, and many design changes, such as changes, additions, and deletions of components, are possible. In the embodiments, the contents where such design changes are possible are emphasized with the notation “embodiments”. However, design changes are allowed even for contents without such notation.

1. A quantum logic gate operation device, comprising:
two-qubit system in which a control qubit and a target qubit are coupled;
a cross resonance drive pulse irradiator that irradiates the control qubit with a cross resonance drive pulse having a eigen frequency of the target qubit;
an echo pulse irradiation unit that irradiates the control qubit with an echo pulse to invert the quantum state of the control qubit; and
a control unit, wherein
the control unit controls the echo pulse irradiation unit such that the echo pulse irradiation unit
irradiates the cross resonance drive pulse of the first phase during the first period of the quantum logic gate operation,
irradiates the cross resonance drive pulse with continuously changing the phase of the cross resonance drive pulse from the first phase to the second phase while maintaining the intensity of the cross resonance drive pulse during the second period of the quantum logic gate operation,
irradiates the cross resonance drive pulse of the second phase during the third period of the quantum logic gate operation and
irradiates an echo pulse during the second period of the quantum logic gate operation.

2. The quantum logic gate operation device according to claim 1, characterized in that the control unit controls the echo pulse irradiation unit to perform frequency modulation of the echo pulse.

3. The quantum logic gate operation device according to claim 2, characterized in that the frequency modulation follows the modulation of the resonance frequency of the control qubit.

4. The quantum logic gate operation device according to claim 3, characterized in that a change in the anharmonicity of the control qubits are added to the frequency modulation of the echo pulse.

5. The quantum logic gate operation device according to claim 1, characterized in that the first phase is 0 and the second phase is π.

6. The quantum logic gate operation device according to claim 1, characterized in that the quantum logic gate operation device is a CNOT gate.

7. The quantum logic gate operation device according to claim 1, characterized in that the quantum logic gate operation device is a root CNOT gate.

8. The quantum logic gate operation device according to claim 1, characterized in that the control qubit and the target qubit are superconducting qubits.

9. The quantum logic gate operation device according to claim 1, characterized in that the control unit includes an arbitrary waveform generator.

10. The quantum logic gate operation device according to claim 1, characterized in that the cross resonance drive pulse irradiation unit and the echo pulse irradiation unit are integrated.

11. The quantum logic gate operation device according to claim 1, characterized in that the cross resonance drive pulse irradiation unit and the echo pulse irradiation unit are separate units.

12. The quantum logic gate operation device according to claim 1, characterized in that the control unit controls the cross resonance drive pulse irradiation unit and the echo pulse irradiation unit to repeatedly perform a set of phase changes of the cross resonance drive pulses and irradiation of the echo pulses.

13. A quantum logic gate operation method for performing quantum logic gate operation using a two-qubit system in which a control qubit and a target qubit are coupled, the method comprising:
a cross resonance drive pulse irradiating step of irradiating the control qubit with a cross resonance drive pulse having a eigen frequency of the target qubit; and
an echo pulse irradiating step of irradiating the control qubit with an echo pulse to invert the quantum state of the control qubit, wherein
the cross resonance drive pulse irradiation step comprises
irradiating the cross resonance drive pulse of the first phase during the first period of the quantum logic gate operation,
irradiating the cross resonance drive pulse with continuously changing the phase of the cross resonance drive pulse from the first phase to the second phase while maintaining the intensity of the cross resonance drive pulse during the second period of the quantum logic gate operation,
irradiating the cross resonance drive pulse of the second phase during the third period of the quantum logic gate operation and
irradiating an echo pulse during the second period of the quantum logic gate operation.

14. A non-transitory computer-readable medium encoded with a program for causing a computer to perform a quantum logic gate operation using a two-qubit system in which a control qubit and a target qubit are coupled, the program comprising:
a cross resonance drive pulse irradiating step of irradiating the control qubit with a cross resonance drive pulse having a eigen frequency of the target qubit; and
an echo pulse irradiating step of irradiating the control qubit with an echo pulse to invert the quantum state of the control qubit, wherein
the cross resonance drive pulse irradiation step comprises irradiating the cross resonance drive pulse of the first phase during the first period of the quantum logic gate operation,
irradiating the cross resonance drive pulse with continuously changing the phase of the cross resonance drive pulse from the first phase to the second phase while maintaining the intensity of the cross resonance drive pulse during the second period of the quantum logic gate operation,
irradiating the cross resonance drive pulse of the second phase during the third period of the quantum logic gate operation and
irradiating an echo pulse during the second period of the quantum logic gate operation.
